(19) United States
(12) Patent Application Publication
(10) Pub. No.: US 2020/0026795 A1
(43) Pub. Date: Jan. 23, 2020

(54) CLUSTERING GEOGRAPHIC FEATURES

(71) Applicant: INTERNATIONAL BUSINESS MACHINES CORPORATION, ARMONK, NY (US)

(72) Inventors: BRENDAN MORE O'FERRALL, Dublin (IE); RICHARD WHELAN, Dublin (IE)

(21) Appl. No.: 16/039,555

(22) Filed: Jul. 19, 2018

(51) Int. Cl. G06F 17/30

(52) U.S. Cl. CPC G06F 17/30601; G06F 17/30572; G06F 17/30241

(57) ABSTRACT

Concepts for clustering geographic features for graphical representation of the geographic features on a geographical map are presented. One example comprises identifying a geographic feature having: a first attribute value; and a geographic location. For each of a plurality of different map zoom levels, a cluster value is generated based on the map zoom level and at least one of the first attribute value and geographic location of the geographic feature. The cluster value for a map zoom level defines a cluster that the geographic feature belongs to for the map zoom level. Cluster values generated for geographic features according to such an example may then be used to group the geographic features for a particular map zoom level.

### BACKGROUND

The present invention relates to clustering geographic features, and more particularly to clustering geographic features for graphical representation of the geographic features on a geographical map.

The present invention also relates to a computer program product comprising computer-readable program code that enables a processor of a system to implement such a method.

The present invention further relates to graphically representing a plurality of geographic features on a geographical map, wherein the plurality of geographic features have been clustered according to proposed embodiments.

The present invention yet further relates to a system for clustering geographic features for graphical representation of the geographic features on a geographical map.

Systems and methods for displaying (e.g. in real time) large numbers of geographic features (or assets) on a geographical map are known. Such systems and methods typically employ strategies to cluster geographic features by location, for example by referencing physical or virtual geographical bounding areas. Clustered (or grouped) geographic features serve to reduce clutter when displayed on a geographical map, thus improving display performance and/or presenting a viewer of the geographical map with more usable and manageable information.

Where such conventional systems and methods cluster geographic features by geographic location, they typically do so at run-time in response to user actions or interactions when using an interactive geographical map display. Two alternative approaches to implementing the clustering process or logic are known: performing clustering at a central processing server or at the client (i.e. user) system itself.

When the clustering process or logic is implemented at the client, a server will typically transport metadata, including location information, for all candidate geographic features across a communication network to the client, thus potentially creating a scalability and/or throughput bottleneck.

Conversely, when the clustering process or logic is implemented (at run-time) on a central processing server in response to requests from a client system, the processing effort required on the server can cause it to become a bottleneck in the event that a large number of users issue requests at the same time (or within a short time period). Attempts to relieve this processing bottleneck have employed techniques such as caching. However, in a scenario where each user may require an individualized view of the server data, and the data serving those views is dynamic, caching may be of limited value.

### SUMMARY

The present invention seeks to provide a computer-implemented method for clustering geographic features for graphical representation of the geographic features on a geographical map.

The present invention seeks to provide a computer-implemented method for graphically representing a plurality of geographic features on a geographical map, wherein the plurality of geographic features are clustered according to proposed embodiments.

The present invention yet further seeks to provide a computer program product including computer program code for implementing a proposed method when executed by a processing unit.

The present invention yet further seeks to provide a processing system adapted to execute this computer program code.

The present invention also seeks to provide a system for clustering geographic features for graphical representation of the geographic features on a geographical map.

The present invention further seeks to provide a system for graphically representing a plurality of geographic features on a geographical map, the plurality of geographic features being clustered by a system according to a proposed embodiment.

According to an aspect of the present invention there is provided a computer-implemented method for clustering geographic features for graphical representation of the geographic features on a geographical map. The method comprises identifying a geographic feature having: a first attribute value; and a geographic location. The method also comprises generating, for each of a plurality of different map zoom levels, a cluster value based on the map zoom level and at least one of the first attribute value and geographic location of the geographic feature. The cluster value for a map zoom level is adapted to define a cluster the geographic feature belongs to for the map zoom level. The method further comprises associating the generated cluster values for each of the plurality of different map zoom levels with the geographic feature.

According to another aspect of the present invention, there is provided a computer-implemented method for graphically representing a plurality of geographic features on a geographical map, the plurality of geographic features being clustered according to a proposed embodiment. The method comprises identifying a selected map zoom level of a plurality of different map zoom levels. For each of the plurality of geographic features, the cluster value associated with the selected geographic feature for the selected map zoom level is identified. The method then also comprises grouping the plurality of geographic features into one or more groups according to the identified cluster values.

According to another aspect of the invention, there is provided a computer program product for clustering geographic features for graphical representation of the geographic features on a geographical map. The computer program product comprises a computer readable storage medium having program instructions embodied therewith, the program instructions executable by a processing unit to cause the processing unit to perform a method according to a proposed embodiment.

According to another aspect of the invention, there is provided a processing system comprising at least one processor and the computer program product according to an embodiment. The at least one processor is adapted to execute the computer program code of said computer program product.

According to yet another aspect of the invention, there is provided a system for clustering geographic features for graphical representation of the geographic features on a geographical map. The system comprises an identification component configured to identify a geographic feature having: a first attribute value; and a geographic location. The system also comprises a calculation component configured to generate, for each of a plurality of different map zoom levels, a cluster value based on the map zoom level and at least one of the first attribute value and geographic location of the geographic feature. The cluster value for a map zoom level is adapted to define a cluster the geographic feature belongs to for the map zoom level. The system also comprises a data management component configured to associate the generated cluster values for each of the plurality of different map zoom levels with the geographic feature.

According to a further aspect of the invention, there is provided a system for graphically representing a plurality of geographic features on a geographical map, the plurality of geographic features being clustered by a system according to a proposed embodiment. The system comprises an interface component configured to identify a selected map zoom level of a plurality of different map zoom levels. The system also comprises a data analysis component configured to, for each of the plurality of geographic features, identify the cluster value associated with the selected geographic feature for the selected map zoom level. The system further comprises a processor configured to group the plurality of geographic features into one or more groups according to the identified cluster values.

### BRIEF DESCRIPTION OF THE DRAWINGS

Preferred embodiments of the present invention will now be described, by way of example only, with reference to the following drawings, in which:

FIG. 1 depicts a pictorial representation of an example distributed system in which aspects of the illustrative embodiments may be implemented;

FIG. 2 is a block diagram of an example system in which aspects of the illustrative embodiments may be implemented;

FIG. 3 is a block diagram of a system for graphically representing a plurality of geographic features on a geographical map according to an embodiment;

FIG. 4, according to the embodiment, illustrates the assignment of geographic features to their associated cluster values for four map zoom levels;

FIG. 5 depicts a graphical representation of a plurality of geographic features on a geographical map at a first map zoom level, wherein the geographic features are grouped into a single cluster/group according to an embodiment;

FIG. 6 depicts a graphical representation of a plurality of geographic features on a geographical map at a second map zoom level, wherein the geographic features are grouped into a six clusters/groups according to an embodiment; and

FIG. 7 illustrates a system for clustering geographic features according to an embodiment.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method may be a process for execution by a computer, i.e. may be a computer-implementable method. The various steps of the method may therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Proposed is a concept for clustering geographic features. By generating a cluster value for a geographic feature for each of a plurality of different map zoom levels, cluster values may define which cluster the geographic feature belongs to at various map zoom levels. By employing such an approach, potentially expensive spatial clustering processes may be undertaken only once, at data ingestion time (or subsequently when a geographic feature is modified, changed or updated for example).

By way of example, when first loading data about geographic features into a geographical map visualization system, proposed embodiments may generate cluster values for each feature and map each cluster value to a map zoom level (or a range of zoom levels). Reference to a ‘map zoom level’ is to be taken to refer to a map view/viewing scale or a map scale of view, and thus represents a viewing scale (or scale of view) at which a map is displayed to a viewer. A large (or high) map zoom level refers to a highly ‘zoomed-in’ view of a map that only displays a small portion (i.e. a small field of view) of the map. Conversely, a small (or low) map zoom level refers to a ‘zoomed-out’ view of a map that displays a large portion (i.e. a large field of view) of the map.

The cluster values may be used to efficiently group geographic features (e.g. in a data structure provided by a server). This may, for example, provide a user with a consistent visual representation of the data as the map zoom level is changed. The cluster values may be stored (or associated with the geographic features) as regular attributes that can be simply and easily retrieved at run-time. In this way, in response to a request from a client, the server may return a clustered, sorted and compressed response object to the client system, where the features can be rendered using the client system's rich rendering capabilities.

To avoid the overhead of carrying out computationally expensive cluster logic at run-time, embodiments may undertake a clustering process (i.e. generate cluster values for a geographic features) at the time each feature is ingested/added. In the event that a feature is subsequently modified or updated, the clustering process can be reapplied to that single geographic feature.

For example, when a new geographic feature is ingested into a system's persistent storage, proposed embodiments may generate cluster values for the feature (e.g. a cluster value for each map zoom level) and then store cluster values along with the feature's regular attributes. In this way, a range of cluster values may be calculated and each cluster value then mapped to a map zoom level so as to provide a user with a consistent visual representation of map features as the user zooms in and out of a geographical map.

At run-time, a client may pass an additional parameter representing the current map zoom level along with its server request. The server may use the zoom level to retrieve the appropriate cluster value along with a geographic feature's regular attributes. The cluster value may then be used by the server to group features efficiently and quickly into single- and multi-member clusters. Because the response data is compressed and pre-clustered, embodiments may transport it rapidly across the network and take advantage of each client system's rich rendering capabilities. This approach may minimize the potential for the central processing server to become a bottleneck in the event that a large number of users issue requests to the server at the same time (or in a small time period).

Proposed concepts may therefore provide an efficient system and method for clustering geographic features. The system and method may be capable of handling a high number (e.g. potentially hundreds of thousands) of features efficiently. Further, the system and method may be capable of serving a different view of the server's data to a large number of concurrent users in a responsive manner. The values, attributes or properties of the geographic features used to determine cluster values (and thus how the geographic features are clustered and rendered) may be dynamic.

Embodiments may thus provide concepts that facilitate the efficient and effective display of geographical features on a geographical map. Such geographical features may be clustered or grouped according to a selected map zoom/viewing level and associated cluster values that have been predetermined for the features (e.g. at time of addition to the system).

By way of further example, embodiments may propose extensions to an existing map visualization system. Such extensions may enable the map visualization system to provide zoom/view-based display of geographic features by leveraging proposed concepts. In this way, a conventional map visualization system may be upgraded by implementing or ‘retro-fitting’ a proposed embodiment.

Illustrative embodiments may provide concepts for analyzing a current visual context (e.g. map zoom level) and then grouping or clustering of geographic features so that the geographic features may be displayed on a geographical map in an efficient or clear manner Dynamic clustering/grouping and visualization concepts may therefore be provided by proposed embodiments.

Modifications and additional steps to a traditional map display system or method may also be proposed which may enhance the value and utility of the proposed concepts.

A function used to generate the cluster values may be arranged to vary cluster density according to the value of one or more parameters passed to it. For example, in some embodiments, the step of generating cluster values may comprise generating, for each of a plurality of different map zoom levels, a cluster value based on the map zoom level and the geographic location of the geographic feature. Embodiments may therefore efficiently cluster features by geographic location for map visualization applications.

For instance, the step of generating a cluster value for a first map zoom level of the plurality of different map zoom levels may comprise: determining the cluster value to be a first value if the geographic location of the geographic feature is within a first geographic area associated with the first map zoom level; and determining the cluster value to be a second value if the geographic location of the geographic feature is within a second geographic area associated with the first map zoom level. Cluster values may therefore be generated in such a way that geographically adjacent features (e.g. geographic features within a predetermined geo-fenced area) may be allocated the same cluster value.

In some embodiments, the step of generating may comprise generating, for each of a plurality of different map zoom levels, a cluster value based on the map zoom level and the first attribute value of the geographic feature. Embodiments may therefore efficiently cluster features based on an attribute other than geographic location.

For example, the step of generating a cluster value for a first map zoom level of the plurality of different map zoom levels may comprise: determining the cluster value to be a first value if the first attribute value of the geographic feature is within a first range of values associated with the first map zoom level; and determining the cluster value to be a second value if the geographic location of the geographic feature is within a second range of values associated with the first map zoom level.

In some embodiments, the step of generating cluster values may comprise determining, for a maximum map zoom level being the largest map zoom level of the plurality of different map zoom levels, the cluster value to be a unique value that cannot be equal to a cluster value for the maximum map zoom level associated with any other geographic features. In this way, there may be provided a map zoom level at which no groups containing multiple geographic features are defined. Thus, if the map is at a sufficiently high zoom level, the groups/clusters may be automatically split into individual geographic features.

Example embodiments may comprise the step of storing, in a data storage component, a data entry for the geographic feature, wherein the data entry comprises the generated cluster values for each of the plurality of different map zoom levels associated with the geographic feature. For instance, when the geographic feature is ingested/added to an embodiment, the generated cluster values may be stored along with the feature's regular attributes. In this way, a new parameter may be provided and stored which can be subsequently used to group/cluster geographic features for a selected map zoom level.

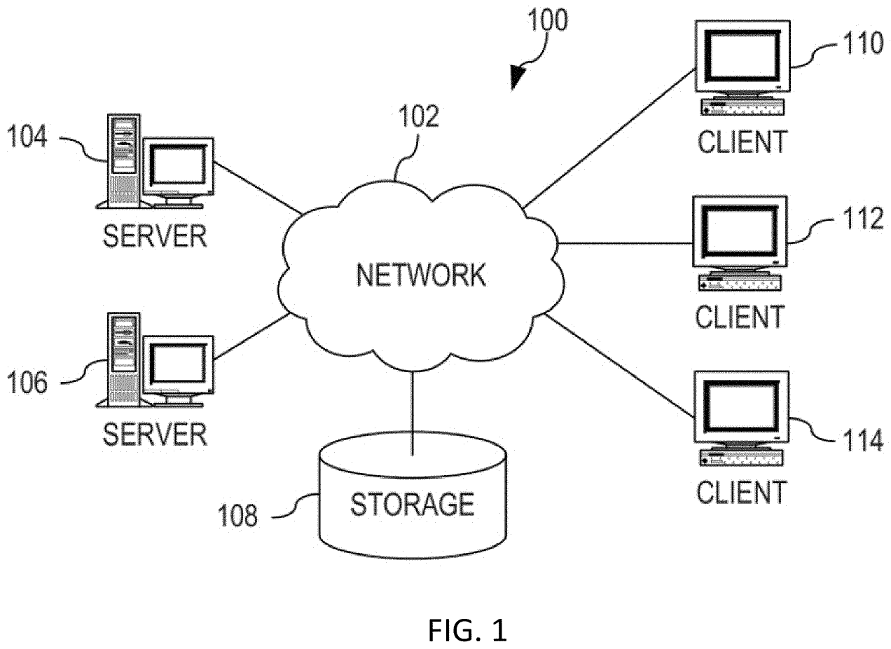

FIG. 1 depicts a pictorial representation of an example distributed system in which aspects of the illustrative embodiments may be implemented. Distributed system 100 may include a network of computers in which aspects of the illustrative embodiments may be implemented. The distributed system 100 contains at least one network 102, which is the medium used to provide communication links between various devices and computers connected together within the distributed data processing system 100. The network 102 may include connections, such as wire, wireless communication links, or fiber optic cables.

In the depicted example, a first 104 and second 106 servers are connected to the network 102 along with a storage unit 108. In addition, clients 110, 112, and 114 are also connected to the network 102. The clients 110, 112, and 114 may be, for example, personal computers, network computers, or the like. In the depicted example, the first server 104 provides data, such as boot files, operating system images, and applications to the clients 110, 112, and 114. Clients 110, 112, and 114 are clients to the first server 104 in the depicted example. The distributed processing system 100 may include additional servers, clients, and other devices not shown.

In the depicted example, the distributed system 100 is the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

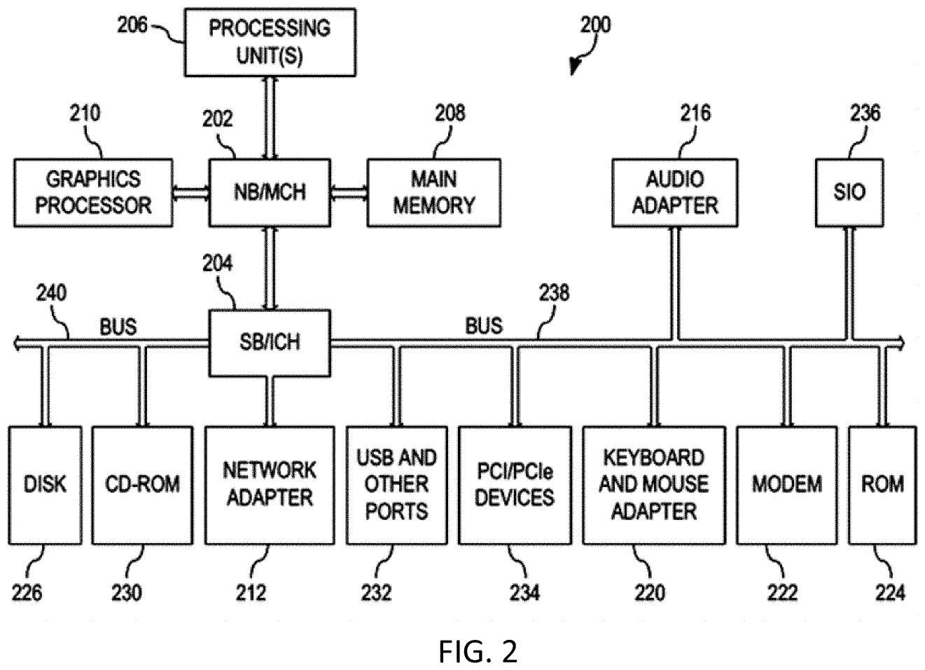

FIG. 2 is a block diagram of an example system 200 in which aspects of the illustrative embodiments may be implemented. The system 200 is an example of a computer, such as client 110 in FIG. 1, in which computer usable code or instructions implementing the processes for illustrative embodiments of the present invention may be located.

In the depicted example, the system 200 employs a hub architecture including a north bridge and memory controller hub (NB/MCH) 202 and a south bridge and input/output (I/O) controller hub (SB/ICH) 204. A processing unit 206, a main memory 208, and a graphics processor 210 are connected to NB/MCH 202. The graphics processor 210 may be connected to the NB/MCH 202 through an accelerated graphics port (AGP).

In the depicted example, a local area network (LAN) adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) ports and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

An operating system runs on the processing unit 206. The operating system coordinates and provides control of various components within the system 200 in FIG. 2. As a client, the operating system may be a commercially available operating system. An object-oriented programming system, such as the Java™ programming system, may run in conjunction with the operating system and provides calls to the operating system from Java™ programs or applications executing on system 200.

As a server, system 200 may be, for example, an IBM® eServer™ System p® computer system, running the Advanced Interactive Executive (AIX®) operating system or the LINUX® operating system. The system 200 may be a symmetric multiprocessor (SMP) system including a plurality of processors in processing unit 206. Alternatively, a single processor system may be employed.

Instructions for the operating system, the programming system, and applications or programs are located on storage devices, such as HDD 226, and may be loaded into main memory 208 for execution by processing unit 206. Similarly, one or more message processing programs according to an embodiment may be adapted to be stored by the storage devices and/or the main memory 208.

The processes for illustrative embodiments of the present invention may be performed by processing unit 206 using computer usable program code, which may be located in a memory such as, for example, main memory 208, ROM 224, or in one or more peripheral devices 226 and 230.

A bus system, such as first bus 238 or second bus 240 as shown in FIG. 2, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the system mentioned previously, without departing from the spirit and scope of the present invention.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

A proposed concept may enhance a map display system by facilitating the clustering or grouping of geographic features in an efficient manner Embodiments may generate cluster values for a geographic feature for a plurality of different map zoom levels. Such cluster values may define which cluster the geographic feature belongs to for each of a plurality of different map zoom levels. The cluster values may be stored as regular attributes that can be simply and easily retrieved in response to a client request. In this way, in response to a request from a client, the server may return a clustered, sorted and compressed response object to the client system, wherein geographic features can be rendered using the client system's rich rendering capabilities.

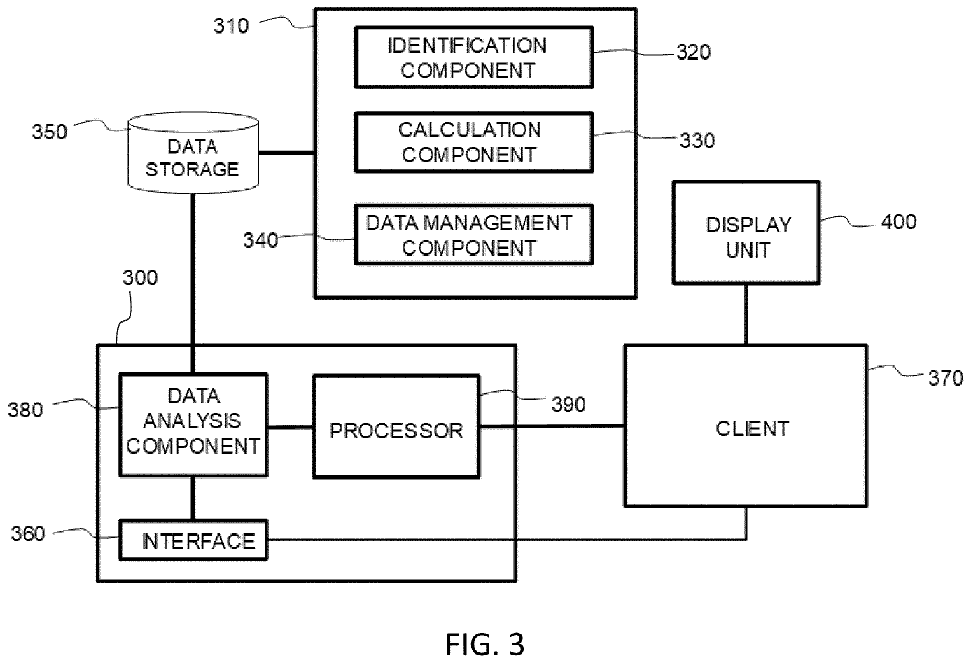

FIG. 3 is a simplified block diagram of a system 300 for graphically representing a plurality of geographic features on a geographical map according to an embodiment. Here, the system 300 is configured to graphically represent geographic features that have been clustered by a sub-system 310, wherein the sub-system comprises a system 310 for clustering geographic features according to an embodiment.

The sub-system 310 for clustering geographic features according to an embodiment comprises an identification component 320 configured to identify a geographic feature having: a first attribute value; and a geographic location. By way of example, the identification component may be configured to receive information relating to a plurality of geographic features, and such information may comprise data regarding the geographic location of each feature and various characteristics, attributes and/or properties of each feature. Examples of such may, for example, include: Identification Number, Name, Description, Status, Type, Owner, etc.

The sub-system 310 for clustering geographic features according to an embodiment also comprises a calculation component 330 that is configured to generate, for each of a plurality of different map zoom levels, a cluster value based on the map zoom level and at least one of the first attribute value and geographic location of the geographic feature. Here, the cluster value for a map zoom level is adapted to define a cluster the geographic feature belongs to for the map zoom level. Put another way, a cluster value may comprise a value (such as a number) or identifier for identifying which cluster/group the feature is a member of for a particular map zoom level.

In this example, the calculation component 330 is configured to generate, for each of a plurality of different map zoom levels, a cluster value based on the map zoom level and the geographic location of the geographic feature. More specifically, the calculation component 330 is configured to: determine the cluster value to be a first value if the geographic location of the geographic feature is within a first geographic area associated with the first map zoom level; and to determine the cluster value to be a second value if the geographic location of the geographic feature is within a second geographic area associated with the first map zoom level. Hence, it will be appreciated that the calculation component 330 of this embodiment is configured to generate cluster values in such a way that geographically adjacent features (e.g. geographic features within the same geographic area) are allocated the same cluster value.

It is, however, to be understood that, in other embodiments, other or additional attributes of the geographic features may be used by the calculation component to determine cluster values (and thus the clusters/groups that the geographic features belong to at various map zoom levels). Other embodiments may therefore cluster/group features based on an attribute other than geographic location.

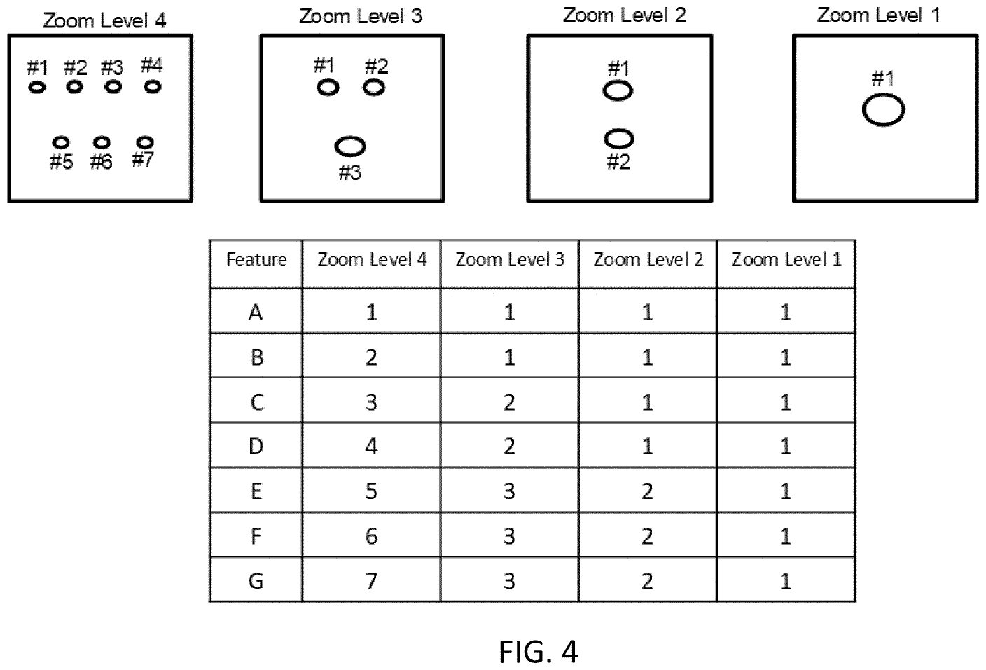

The sub-system 310 for clustering geographic features according to an embodiment also comprises a data management component 340 that is configured to associate the generated cluster values for each of the plurality of different map zoom levels with the geographic feature. By way of example, the data management component 340 may assign a geographic feature to its cluster values by defining a row in a table such as Table 1 below (which is also depicted in FIG. 4):

TABLE 1

| | Zoom | Zoom | Zoom | Zoom |
|---|---|---|---|---|
| Feature | Level 4 | Level 3 | Level 2 | Level 1 |
| A | 1 | 1 | 1 | 1 |
| B | 2 | 1 | 1 | 1 |
| C | 3 | 2 | 1 | 1 |
| D | 4 | 2 | 1 | 1 |
| E | 5 | 3 | 2 | 1 |
| F | 6 | 3 | 2 | 1 |
| G | 7 | 3 | 2 | 1 |

In Table 1 above, a row is defined for each geographic feature A-G. The row of a geographic feature details the cluster value associated with the geographic feature for each map zoom level.

From Table 1 above, it will be appreciated that, for the maximum map zoom level (i.e. “Zoom Level 4”—the largest map zoom level) of the plurality of different map zoom levels, each geographic feature has a cluster value which is a unique (i.e. a value that does not equal that of any other geographic feature for the maximum map zoom level). In this way, there may be provided a map zoom level (e.g. “Zoom Level 4”) at which few, if any, groups containing multiple geographic features are defined. Put another way, for the maximum map zoom level, there are no grouped or clustered geographic features but there are, instead, only individual geographic features.

Also, from Table 1, it will be appreciated that, for the minimum map zoom level (i.e. “Zoom Level 1”—the smallest map zoom level) of the plurality of different map zoom levels, all of the geographic features have the same cluster value. In this way, there is provided a map zoom level (“Zoom Level 1”) at which only one group containing all of the geographic features is defined. Put another way, for the minimum map zoom level, there is only a single cluster/group which includes all of the geographic features A-G.

The sub-system 310 for clustering geographic features is configured to store the generated cluster values in a data storage component 350. In this example, a data entry for each geographic feature may be stored, wherein the data entry for a geographic feature comprises the generated cluster values for each of the plurality of different map zoom levels. For instance, the data storage component 350 may be configured to store the values in the form of a table such as Table 1 above, wherein each row of the table is a data entry for a particular geographic feature.

The system 300 for graphically representing a plurality of geographic features on a geographical map is configured to graphically represent geographic features that have been clustered by the sub-system 310.

The system 300 comprises an interface component 360 configured to identify a selected map zoom level of a plurality of different map zoom levels. In the example of FIG. 3, the interface component 360 is configured to receive an indication of the selected map zoom level from a client (e.g. as part of a display request and/or via a user input).

The system 300 also comprises a data analysis component 380 configured to, for each of the plurality of geographic features, identify the cluster value associated with the selected geographic feature for the selected map zoom level. Accordingly, based on the a selected map zoom level identified by the interface component 360, the data analysis component 380 queries the data storage component 350 and retrieves the cluster value of each of the plurality of geographic features for the selected map zoom level.

By way of example, where the values are stored in the form of a table similar to Table 1, data analysis component 380 may be thought of as retrieving the cluster values of the single column that is associated with the selected map zoom level. Taking the example of Table 1 and FIG. 4, if the selected map zoom level equals “Zoom Level 1”, the data analysis component 380 would be configured to retrieve the cluster values in the furthest column to the right, namely the cluster value “1” for each of the geographic features.

Based on the retrieved cluster values, a processor 390 of the system 300 groups the plurality of geographic features into one or more groups. For example, for selected map zoom level “Zoom Level 1”, all features are grouped into a single group “#1”. Similarly, for selected map zoom level “Zoom Level 2”, features A-D are grouped into a first group “#1” and features E-G are grouped into a second group “#2”.

The processor 390 is configured to return data representative of the grouped features to the client 370, which then processes the returned data and passes it to a display unit 400 for rendering/display of the grouped features.

From the above description, it will be understood that proposed embodiments may employ the concept of applying a clustering process once (e.g. using system 310), at ingestion time, rather than at run-time in response to each individual client request. Generated cluster values may be stored along with a feature's regular attributes and the cluster values may be simply retrieved from the data storage component 350 at run time.

It will also be understood that the cluster values may efficiently group and compress response data provided to the client 370. In this way, embodiments may take advantage of each client system's rich capabilities to render map features.

By way of further explanation, a description of a fully-working prototype embodiment will now be provided. In this embodiment, a relational database management system (such as “DB2” developed by IBM®) is used as persistent storage for geographic feature metadata and DB2's Spatial Extender package is used to process spatial data.

Cluster Implementation in Database

The first step in implementing the cluster strategy is to add six additional fields (e.g. columns) in a database table, to store the six generated cluster values of for the six map zoom levels:

ALTER TABLE table_name ADD COLUMN cluster_value_1 BIGINT;
ALTER TABLE table_name ADD COLUMN cluster_value_2 BIGINT;
ALTER TABLE table_name ADD COLUMN cluster_value_3 BIGINT;
ALTER TABLE table_name ADD COLUMN cluster_value_4 BIGINT;
ALTER TABLE table_name ADD COLUMN cluster_value_5 BIGINT;
ALTER TABLE table_name ADD COLUMN cluster_value_6 BIGINT;

The key generator function used in this implementation to generate cluster values is included as part of DB2's Spatial Extender package; it computes a value for the centroid of each feature on a space filling curve.

However, a person skilled in the art of geometry should be able to develop an alternative approach, for example using a grid system where the granularity of the grid varies with map zoom level. The key generator function takes a geographic feature's geographic location as input, in addition to parameters which represent the spatial properties of the geographic features. The x and y scale parameters in particular are used to vary the granularity of the cluster calculations as follows:

```
        CREATE OR REPLACE FUNCTION computeClusterValue ( g
db2gse.ST_Geometry,
        xOffset DOUBLE, xScale DOUBLE, yOffset DOUBLE, yScale DOUBLE)
        RETURNS BIGINT
        LANGUAGE SQL
        DETERMINISTIC
        NO EXTERNAL ACTION
        RETURN SELECT zValue
        PROM TABLE ( db2gse.GseZordIdxKeyGen ( g..ST_SrsId( ),
        (g..ST_MinX( ) + g..ST_MaxX( ) / 2),
        (g..ST_MinX( ) + g..ST_MaxX( ) / 2),
        (g..ST_MinY( ) + g..ST_MaxY( ) / 2),
        (g..ST_MinY( ) + g..ST_MaxY( ) / 2),
        xOffset, xScale, yOffset, yScale ) ) AS t;
```

The embodiment therefore employs the key generator function to create an additional column in a table, and a cluster index/value on that (single) column may then be defined. It will be appreciated that, in accordance with proposed concepts, the use of cluster values for various map zoom levels enables variable clustering of features on a map for a range of zoom levels.

Here, six columns are employed to hold a range of cluster values that will each be mapped to a zoom level, or a range of zoom levels. Triggers are defined on the table with spatial data to compute the six cluster values as and when features are ingested into the system as follows:

```
        CREATE OR REPLACE TRIGGER
“LOCATION_TABLE_CLUSTERVALUE_INSERT”
        NO CASCADE
        BEFORE INSERT ON “LOCATION_TABLE”
        REFERENCING NEW AS n
        FOR EACH ROW MODE DB2SQL
        SET n.cluster_value_1 = computeClusterValue(n.location, −180, 10000, −90,
        10000),
        n.cluster_value_2 = computeClusterValue(n.location, −180, 1000, −90, 1000),
        n.cluster_value_3 = computeClusterValue(n.location, −180, 100, −90, 100),
        n.cluster_value_4 = computeClusterValue(n.location, −180, 10, −90, 10),
        n.cluster_value_5 = computeClusterValue(n.location, −180, 1, −90, 1),
        n.cluster_value_6 = computeClusterValue(n.location, −180, 0.1, −90, 0.1);
        CREATE OR REPLACE TRIGGER
“LOCATION_TABLE_CLUSTERVALUE_UPDATE”
        NO CASCADE
        BEFORE UPDATE OF “LOCATION” ON “LOCATION_TABLE”
        REFERENCING NEW AS n
        FOR EACH ROW MODE DB2SQL
        SET n.cluster_value_1 = computeClusterValue(n.location, −180, 10000, −90,
        10000),
        n.cluster_value_2 = computeClusterValue(n.location, −180, 1000, −90, 1000),
        n.cluster_value_3 = computeClusterValue(n.location, −180, 100, −90, 100),
        n.cluster_value_4 = computeClusterValue(n.location, −180, 10, −90, 10),
        n.cluster_value_5 = computeClusterValue(n.location, −180, 1, −90, 1),
        n.cluster_value_6 = computeClusterValue(n.location, −180, 0.1, −90, 0.1);
```

Here, the scale value passed to the function ranges from 10,000 to 0.1, where the smaller the value of the scale parameter the more aggressive the clustering.

In use, a client provides a current zoom level as an additional parameter within a cluster service request.

As there are more zoom levels than cluster values, a mapping table is used to map each cluster value to one or more zoom levels. In this example, The values chosen in the mapping table were determined through trial and error:

CREATE TABLE “ZOOMLEVEL_CLUSTERLEVEL_MAP” (
“ZOOM_LEVEL” INTEGER NOT NULL,
“CLUSTER_LEVEL” INTEGER
)
ORGANIZE BY ROW
DATA CAPTURE CHANGES
IN “USERSPACE1”
COMPRESS NO;

Cluster Service

The client system sends a request to the server (e.g. system 300 of FIG. 3) to return a clustered response object according to current map boundary, filter and layer selections. The client passes the current zoom level of the map display to the server along with the service request and the server then uses the mapping table to retrieve the corresponding cluster value. Here, the cluster value is read from the database along with regular feature attributes.

To improve efficiency, the bounding area of the client's map display may be divided into a number of equal-sized tiles, where the number of tiles is varied according to the current zoom level. The server can then issue parallel requests for each tile to the database and combine the responses into a single result set.

The result set comprises metadata for all candidate features, including geographic location, cluster value and attributes of interest.

The server groups the geographic features retrieved from the database using the cluster value for a geographic feature to determine which group the feature belongs to. Each resulting group thus consists of one or more members. For single-member groups, the server retains all attribute fields that were retrieved from the database; this affords the client system the ability to handle a single-member group as it would an individual geographic feature in a response object for a non-clustered service. For multi-member groups, the server discards secondary attributes and retains selected primary attributes; this provides for compression of the response object that is returned to the client system. Should the client system require access to the discarded secondary attributes may issue an additional service request for these in response to a user action.

The application server can enrich each group/cluster object with additional cluster-level attributes, including an ID field, a STATUS field, a LOCATION field and a TYPE field. The STATUS field of the cluster can be an aggregation of the value of the STATUS field of the individual cluster members. The final cluster field in this implementation is called MEMBERS, a JSON array of the feature attributes of each member of the cluster.

An example of two cluster objects returned by the cluster service in the present embodiment (one multi-member and the other single-member) is as follows:

[
{
“ID”:“CLUSTERID_TANKl20”,
“LOCATION”:“POINT (−86.0815506 41.7069923)”,
“STATUS”:1,
“MEMBER_COUNT”:7,
“TYPE_NAME”:“Tank”,
“MEMBERS”:[
{
“ID”:“TANK9955”,
“NAME”:“TANK9955”, // PRIMARY FIELDS ONLY
“STATUS”:0
,
{
“ID”:“TANK32735”,
“NAME”:“TANK32735”,
“STATUS”:0
},
{
“ID”:“TANK53817”,
“NAME”:“TANK53817”,
“STATUS”:1
},
{
“ID”:“TANK27030”,
“NAME”:“TANK27030”,
“STATUS”:0
},
{
“ID”:“TANK18035”,
“NAME”:“TANK18035”,
“STATUS”:0
},
{
“ID”:“TANK19794”,
“NAME”:“TANK19794”,
“STATUS”:0
},
{
“ID”:“TANK29321”,
“NAME”:“TANK29321”,
“STATUS”:0
}
]
},
{
“ID”:“CLUSTERID_TANK21”,
“LOCATION”:“POINT (−86.0590078 41.7312146)”,
“STATUS”:0,
“MEMBER_COUNT”:1,
“TYPE_NAME”:“Tank”,
“MEMBERS”:[
{
“RENDER_COLOR”,“#0000FF”,
“RENDER_THICKNESS”:0.5,
“PRIMARY_MEASUREMENT_NAME”:“Level”,
“PRIMARY_MEASUREMENT_UNIT”:“FEET”, // PRIMARY+SECONDARY

FIELDS

“PRIMARY_MEASUREMENT_VALUE”:10,
“RENDER_ICON”:“tanklevel.png”,
“ASSET_ID”:160214,
“NAME”:“TANK39331”,
“PRIMARY_MEASUREMENT_START_TIME”:“2017:06:21 09:12:10”,
“LINKED_ASSET_COLOR”:“#00FF00”,
“TENANT_ID”:1001,
“ID”:“TANK39331”
}
]
}
]

The resulting clustered, sorted and compressed response object is returned to the client in the form of a JSON array. The client is then responsible for rendering the clusters on the map display.

As part of this implementation we adorn each cluster icon with a label that shows the number of members in the cluster. In this implementation a status indicator reflecting the value of the cluster's aggregate STATUS field is positioned above the cluster icon. As the user zooms in on the map display the clusters will start to split into smaller clusters.

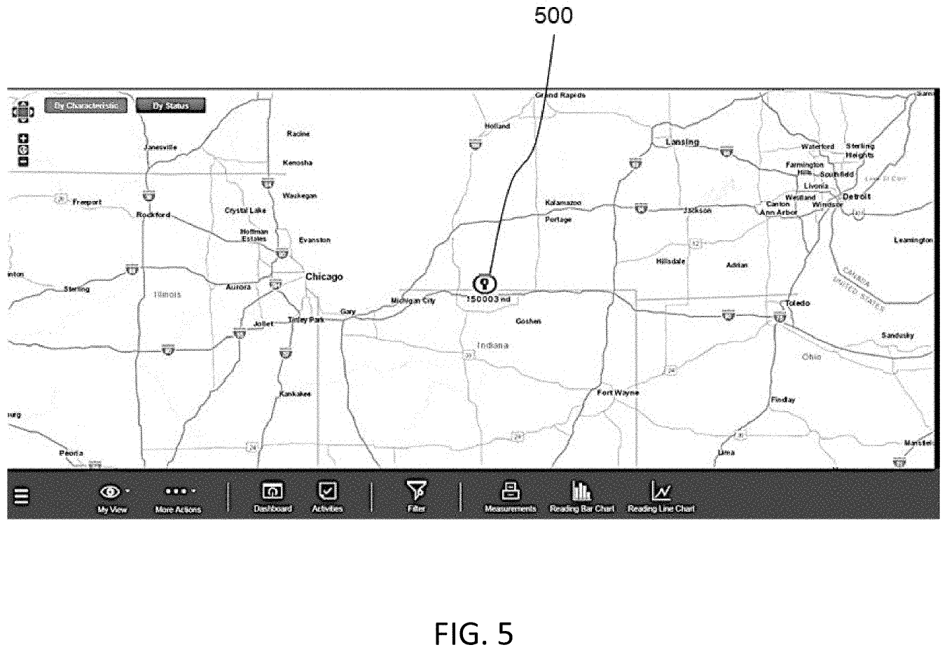

By way of example, FIG. 5 depicts a graphical representation of a plurality of geographic features on a geographical map, wherein the geographic features are grouped into a single cluster/group 500 for a first map zoom level.

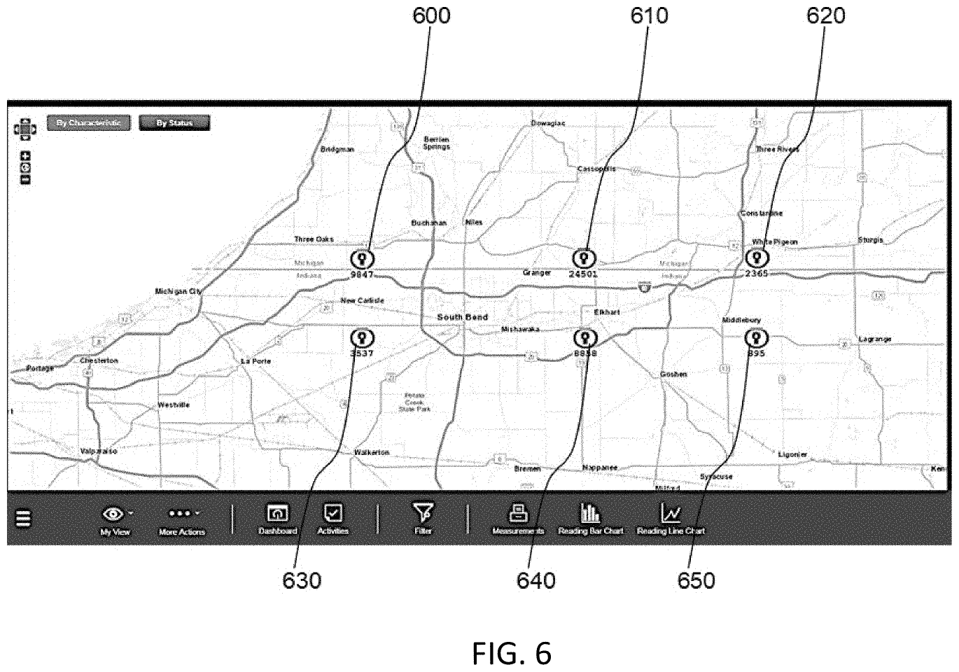

FIG. 6 depicts a graphical representation of a plurality of geographic features on a geographical map, wherein the geographic features are grouped into a six clusters/groups 600-650 for a second (more zoomed-in) map zoom level.

Thus, FIGS. 5-6 illustrate how the distribution and size of the groups/clusters changes as the user zooms in/out on the displayed geographical map.

In this implementation the appearance of single-member clusters may be different, in accordance with how an administrator has configured the system. The client system may also be configured to respond differently when a user clicks on a single-member cluster.

As the client system has access to the full complement of primary and secondary attributes for single-member clusters, it may offer the same range of functionality as it would in the case of an individual feature returned by a non-clustered service. In this implementation, when a user clicks on a single-member cluster a property dialog displaying the values of its attributes is presented to the user and the client system will also populate one or more related widgets with that feature's metadata.

When a user selects a multi-member cluster they are presented with a dynamic property dialog; one of the widgets in the dialog is a drop down list populated with the value of one of the primary attributes of the cluster members. When the user selects an item from the drop-down list the client will issue a request to the server to retrieve a full complement of metadata belonging to the selected item. The client system then uses this information to populate the property dialog with attributes belonging to the currently selected cluster member. Further, the client system can populate one or more related widgets with metadata belonging to the currently selected cluster member.

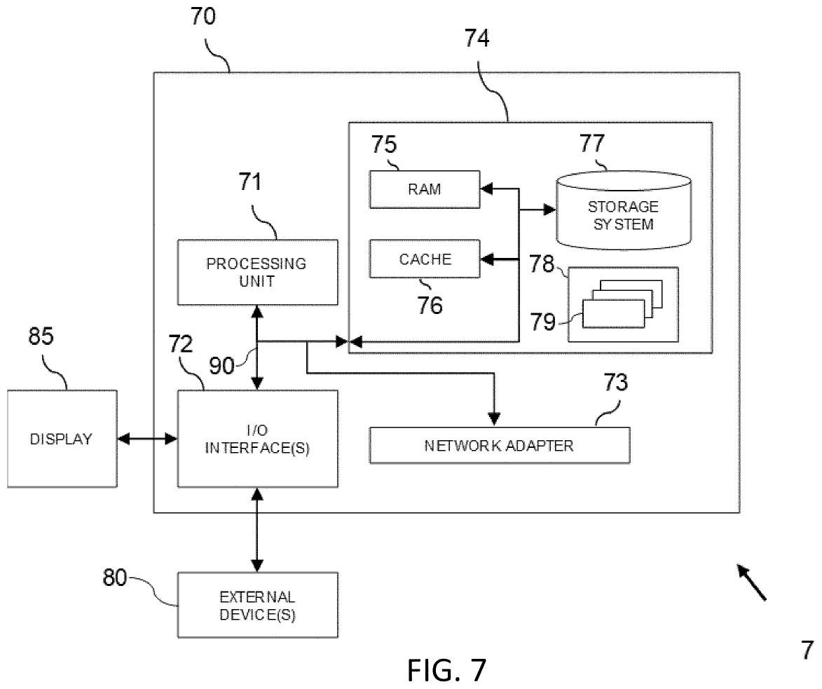

By way of example, as illustrated in FIG. 7, embodiments may comprise a computer system 70, which may form part of a networked system 7. The components of computer system/server 70 may include, but are not limited to, one or more processing arrangements, for example comprising processors or processing units 71, a system memory 74, and a bus 90 that couples various system components including system memory 74 to processing unit 71.

Bus 90 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 70 typically includes a variety of computer system readable media. Such media may be any available media that is accessible by computer system/server 70, and it includes both volatile and non-volatile media, removable and non-removable media.

System memory 74 can include computer system readable media in the form of volatile memory, such as random access memory (RAM) 75 and/or cache memory 76. Computer system/server 70 may further include other removable/non-removable, volatile/non-volatile computer system storage media. By way of example only, storage system 74 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 90 by one or more data media interfaces. As will be further depicted and described below, memory 74 may include at least one program product having a set (e.g., at least one) of program modules that are configured to carry out the functions of embodiments of the invention.

Program/utility 78, having a set (at least one) of program modules 79, may be stored in memory 74 by way of example, and not limitation, as well as an operating system, one or more application programs, other program modules, and program data. Each of the operating system, one or more application programs, other program modules, and program data or some combination thereof, may include an implementation of a networking environment. Program modules 79 generally carry out the functions and/or methodologies of embodiments of the invention as described herein.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73. As depicted, network adapter 73 communicates with the other components of computer system/server 70 via bus 90. It should be understood that although not shown, other hardware and/or software components could be used in conjunction with computer system/server 70. Examples, include, but are not limited to: microcode, device drivers, redundant processing units, external disk drive arrays, RAID systems, tape drives, and data archival storage systems, etc.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for clustering geographic features for graphical representation of the geographic features on a geographical map, wherein the method comprises:
identifying a geographic feature having: a first attribute value; and a geographic location;
generating, for each of a plurality of different map zoom levels, a cluster value based on the map zoom level and at least one of the first attribute value and geographic location of the geographic feature, wherein the cluster value for a map zoom level is adapted to define a cluster the geographic feature belongs to for the map zoom level; and
associating the generated cluster values for each of the plurality of different map zoom levels with the geographic feature.

2. The method of claim 1, wherein the step of generating comprises generating, for each of a plurality of different map zoom levels, a cluster value based on the map zoom level and the geographic location of the geographic feature.

3. The method of claim 2, wherein the step of generating a cluster value for a first map zoom level of the plurality of different map zoom levels comprises:
determining the cluster value to be a first value if the geographic location of the geographic feature is within a first geographic area associated with the first map zoom level; and
determining the cluster value to be a second value if the geographic location of the geographic feature is within a second geographic area associated with the first map zoom level.

4. The method of claim 1, wherein the step of generating comprises generating, for each of a plurality of different map zoom levels, a cluster value based on the map zoom level and the first attribute value of the geographic feature.

5. The method of claim 4, wherein the step of generating a cluster value for a first map zoom level of the plurality of different map zoom levels comprises:
determining the cluster value to be a first value if the first attribute value of the geographic feature is within a first range of values associated with the first map zoom level; and
determining the cluster value to be a second value if the geographic location of the geographic feature is within a second range of values associated with the first map zoom level.

6. The method of claim 1, further comprising:
storing, in a data storage component, a data entry for the geographic feature, wherein the data entry comprises the generated cluster values for each of the plurality of different map zoom levels associated with the geographic feature.

7. The method of claim 6, wherein the data entry further comprises at least one of: an identifier of the geographic feature; the first attribute value of the geographic feature; and the geographic location of the geographic feature.

8. The method of claim 1, wherein the step of generating comprises determining, for a maximum map zoom level being the largest map zoom level of the plurality of different map zoom levels, the cluster value to be a unique value that cannot be equal to a cluster value for the maximum map zoom level associated with any other geographic features.

9. A computer-implemented method for graphically representing a plurality of geographic features on a geographical map, the plurality of geographic features being clustered according to claim 1, wherein the method comprises:
identifying a selected map zoom level of a plurality of different map zoom levels;
for each of the plurality of geographic features, identifying the cluster value associated with the selected geographic feature for the selected map zoom level; and
grouping the plurality of geographic features into one or more groups according to the identified cluster values.

10. The method of claim 9, further comprising:
associating with a group the first attribute value of a geographic feature within the group.

11. The method of claim 10, wherein each of the plurality of geographic features further comprises a second attribute value, and wherein the method further comprises:
based on the selected map zoom level, associating with a group the second attribute value of a geographic feature within the group.

12. The method of claim 9, further comprising:
generating instructions for graphically representing the plurality of geographic features on a geographical map, wherein the generated instructions comprise instructions to graphically represent the one or more groups on a geographical map.

13. The method of claim 12, wherein the generated instructions further comprise instructions to graphically represent a group at a relative position within the graphical map based on the geographic location of a geographic feature within the group.

14. The method of claim 12, wherein the generated instructions further comprise instructions to graphically represent a group with a graphical property based on the first attribute value of a geographic feature within the group.

15. A computer program product for clustering geographic features for graphical representation of the geographic features on a geographical map, the computer program product comprising a computer readable storage medium having program instructions embodied therewith, the program instructions executable by a processing unit to cause the processing unit to perform a method comprising:
identifying a geographic feature having: a first attribute value; and a geographic location;
generating, for each of a plurality of different map zoom levels, a cluster value based on the map zoom level and at least one of the first attribute value and geographic location of the geographic feature, wherein the cluster value for a map zoom level is adapted to define a cluster the geographic feature belongs to for the map zoom level; and
associating the generated cluster values for each of the plurality of different map zoom levels with the geographic feature.

16. A processing system comprising at least one processor and the computer program product of claim 15, wherein the at least one processor is adapted to execute the computer program code of said computer program product.

17. A system for clustering geographic features for graphical representation of the geographic features on a geographical map, wherein the system comprises:
an identification component configured to identify a geographic feature having: a first attribute value; and a geographic location;
a calculation component configured to generate, for each of a plurality of different map zoom levels, a cluster value based on the map zoom level and at least one of the first attribute value and geographic location of the geographic feature, wherein the cluster value for a map zoom level is adapted to define a cluster the geographic feature belongs to for the map zoom level; and
a data management component configured to associate the generated cluster values for each of the plurality of different map zoom levels with the geographic feature.

18. The system of claim 17, wherein the calculation component is configured to generate, for each of a plurality of different map zoom levels, a cluster value based on the map zoom level and the geographic location of the geographic feature.

19. The system of claim 17, further comprising a data storage component configured to store a data entry for the geographic feature, wherein the data entry comprises the generated cluster values for each of the plurality of different map zoom levels associated with the geographic feature.

20. A system for graphically representing a plurality of geographic features on a geographical map, the plurality of geographic features being clustered by a system according to claim 17, wherein the system comprises:
an interface component configured to identify a selected map zoom level of a plurality of different map zoom levels;
a data analysis component configured to, for each of the plurality of geographic features, identify the cluster value associated the selected geographic feature for the selected map zoom level; and
a processor configured to group the plurality of geographic features into one or more groups according to the identified cluster values.
